(19) United States
(12) Patent Application Publication
(10) Pub. No.: US 2025/0193711 A1
(43) Pub. Date: Jun. 12, 2025

(54) EVALUATION SYSTEM FOR DETERMINING A NETWORK CONNECTIVITY PERFORMANCE ROAD MAP

(71) Applicant: GM Global Technology Operations LLC, Detroit, MI (US)

(72) Inventors: Angelos Angelopoulos, Carrboro, NC (US); Paolo Giusto, Brentwood, CA (US); Arun Adiththan, Sterling Heights, MI (US); Md Mhafuzul Islam, Warren, MI (US); Azeem Sarwar, Rochester Hills, MI (US)

(21) Appl. No.: 18/536,810

(22) Filed: Dec. 12, 2023

(51) Int. Cl. H04W 24/08; G01C 21/00

(52) U.S. Cl. CPC H04W 24/08; G01C 21/3807; G01C 21/3841

(57) ABSTRACT

An evaluation system that determines a network connectivity performance road map includes one or more back-end servers in wireless communication with a plurality of vehicles located in a geographic region by a wireless communication network and one or more road map databases in electronic communication with the one or more back-end servers. The one or more road map databases store a map data road graph of the geographic region including a plurality of nodes connected by a plurality of edges and one or more statistical measures corresponding to the plurality of overall performance metrics of the wireless communication network for each of the plurality of nodes. The one or more back-end servers determine the network connectivity performance road map of the geographical region based on the statistics corresponding to the plurality of overall performance metrics for each of the plurality of nodes and each of the plurality of edges.

### INTRODUCTION

The present disclosure relates to an evaluation system that includes one or more back-end servers in wireless communication with a plurality of vehicles by a wireless communication network. The back-end servers determine a network connectivity performance road map indicating overall performance metrics of the wireless communication network, where the overall performance metrics include performance metrics of the back-end servers.

A connected vehicle is in communication with other vehicles, mobile devices, cloud servers, and infrastructure by one or more wireless networks to support various features and services such as, but not limited to, data streaming, navigation, and autonomous driving functionality. In some instances, the features and services provided by the wireless network may be impacted by connectivity issues that arise from situations such as high demand for network bandwidth, high loads experienced by the back-end server coupled with limited availability, and intermittent network coverage. It is to be appreciated that the connectivity issues depend upon the current geographical location of the connected vehicle, the time of day, and the load experienced by the network and the associated back-end servers. For example, a connected vehicle may not experience issues when traveling through urban areas that are densely populated and tend to have a robust wireless network infrastructure. However, the same vehicle may experience a loss in connectivity or a reduction in quality-of-service (QoS) at different times of day in the same urban area. The same vehicle may also experience a loss in connectivity or QoS when traveling through regions that are sparsely populated or rural areas, which tend to have limited wireless network infrastructure.

Thus, while connected vehicles achieve their intended purpose, there is a need in the art for an improved approach for enabling vehicular wireless communication.

### SUMMARY

According to several aspects, an evaluation system that determines a network connectivity performance road map is disclosed. The evaluation system includes one or more back-end servers in wireless communication with a plurality of vehicles located in a geographic region by a wireless communication network, where the plurality of vehicles collect a plurality of overall performance metrics of the wireless communication network. The evaluation system also includes one or more road map databases in electronic communication with the one or more back-end servers, where the one or more road map databases store a map data road graph of the geographic region including a plurality of nodes connected by a plurality of edges and one or more statistical measures corresponding to the plurality of overall performance metrics of the wireless communication network for each of the plurality of nodes. The one or more back-end servers execute instructions to calculate the one or more statistical measures corresponding to the plurality of overall performance metrics of the wireless communication network for each of the plurality of edges of the map data road graph of the geographic region. The one or more back-end servers determine the network connectivity performance road map of the geographical region based on the one or more statistical measures corresponding to the plurality of overall performance metrics for each of the plurality of nodes and each of the plurality of edges.

In another aspect, the one or more one or more network servers are in wireless communication with the one or more back-end servers by the wireless communication network, where the one or more network servers transmit live network performance data of the wireless communication network to the one or more back-end servers.

In yet another aspect, the one or more back-end servers execute instructions to annotate each of the plurality of nodes that are part of the network connectivity performance road map with the live network performance data of the wireless communication network.

In an aspect, the one or more back-end servers execute instructions to receive, from a vehicle that is part of the plurality of vehicles, a navigational request for one of the following: the network connectivity performance road map of the geographical region and a navigational route calculated based on the network connectivity performance road map, and transmit either the network connectivity performance road map or the navigational route over the wireless communication network to the vehicle that transmitted the navigational request.

In another aspect, the one or more back-end servers calculate the one or more statistical measures corresponding to the plurality of overall performance metrics of the wireless communication network for each of the plurality of edges of the map data road graph of the geographic region by averaging of the one or more statistical measures corresponding to the plurality of overall performance metrics for two neighboring nodes connected to one another by a single edge, and assigning an average value for the two neighboring nodes to the single edge.

In yet another aspect, the one or more back-end servers execute instructions to receive, from one of the vehicles, a route request including a start location and an end destination, and in response to receiving the route request, calculate a distance cost for each of the plurality of edges that are part of the network connectivity performance road map. The one or more back-end servers calculate a time cost for each of the plurality of edges that are part of the network connectivity performance road map.

In an aspect, the one or more back-end servers execute instructions to combine the distance cost and the time cost together based on a weight value associated with the distance cost and a weight value associated with the time cost to determine a basic edge cost associated with each of the edges that are part of the network connectivity performance road map, and determine one or more basic route plans by minimizing the basic edge cost associated with each of the edges located between the start location and the end destination of the route request.

In another aspect, the one or more back-end servers execute instructions to in response to receiving the route request, calculate an offloading cost for each of the plurality of edges that are part of the network connectivity performance road map, and calculate a network live latency cost for each of the plurality of edges that are part of the network connectivity performance road map.

In yet another aspect, the one or more back-end servers execute instructions to combine the offloading cost and the network live latency cost together based on a weight value associated with the offloading cost and the weight value associated with the network live latency cost to determine a network performance edge cost associated with each of the plurality of edges that are part of the network connectivity performance road map, and determine one or more network performance-based route plans by minimizing the network performance edge cost associated with each of the plurality of edges located between the start location and the end destination of the route request.

In an aspect, the overall performance metrics of the wireless communication network include one or more of the following: an end-to-end latency, wireless communication latency, network bandwidth, bandwidth utilization, jitter, server computational time, server resource utilization, server geographic location, server hardware, and a geographic location of a specific vehicle collecting the corresponding overall performance data.

In another aspect, a method for determining a network connectivity performance road map by an evaluation system is disclosed. The method includes receiving, from a vehicle that is part of a plurality of vehicles located in a geographic region, a navigational request for one of the following: the network connectivity performance road map of the geographical region by one or more back-end servers and a navigational route calculated based on the network connectivity performance road map, where the one or more back-end servers are in wireless communication with the plurality of vehicles by a wireless communication network and the plurality of vehicles collect a plurality of overall performance metrics of the wireless communication network. In response to receiving the navigational request, the one or more back-end servers calculate one or more statistical measures corresponding to the plurality of overall performance metrics of the wireless communication network for each of a plurality of edges of a map data road graph of the geographic region that are stored in one or more road map databases that are in electronic communication with the one or more back-end servers. The map data road graph of the geographic region includes a plurality of nodes connected by the plurality of edges and the one or more road map databases store one or more statistical measures corresponding to the plurality of overall performance metrics of the wireless communication network for each of the plurality of nodes. The method includes determining the network connectivity performance road map of the geographical region based on the one or more statistical measures corresponding to the plurality of overall performance metrics for each of the plurality of nodes and each of the plurality of edges.

In another aspect, the method further includes transmitting, by one or more one or more network servers in wireless communication with the one or more back-end servers by the wireless communication network, live network performance data of the wireless communication network to the one or more back-end servers.

In yet another aspect, the method further includes annotating each of the plurality of nodes that are part of the network connectivity performance road map with the live network performance data of the wireless communication network.

In an aspect, the method further includes receiving, from the vehicle, a route request including a start location and an end destination, in response to receiving the route request, calculating a distance cost for each of the plurality of edges that are part of the network connectivity performance road map, and calculating a time cost for each of the plurality of edges that are part of the network connectivity performance road map.

In another aspect, the method further includes combining the distance cost and the time cost together based on a weight value associated with the distance cost and a weight value associated with the time cost to determine a basic edge cost associated with each of the edges that are part of the network connectivity performance road map, and determining one or more basic route plans by minimizing the basic edge cost associated with each of the edges located between the start location and the end destination of the route request.

In yet another aspect, the method further includes in response to receiving the route request, calculating an offloading cost for each of the plurality of edges that are part of the network connectivity performance road map, and calculating a network live latency cost for each of the plurality of edges that are part of the network connectivity performance road map.

In an aspect, the method further includes combining the offloading cost and the network live latency cost together based on a weight value associated with the offloading cost and the weight value associated with the network live latency cost to determine a network performance edge cost associated with each of the plurality of edges that are part of the network connectivity performance road map, and determining one or more network performance-based route plans by minimizing the network performance edge cost associated with each of the plurality of edges located between the start location and the end destination of the route request.

In another aspect, an evaluation system that determines a network connectivity performance road map is disclosed. The evaluation system includes one or more back-end servers in wireless communication with a plurality of vehicles located in a geographic region by a wireless communication network, where the plurality of vehicles collect a plurality of overall performance metrics of the wireless communication network. The evaluation system includes one or more one or more network servers in wireless communication with the one or more back-end servers by the wireless communication network, where the one or more network servers transmit live network performance data of the wireless communication network to the one or more back-end servers. The evaluation system also includes one or more road map databases in electronic communication with the one or more back-end servers, where the one or more road map databases store a map data road graph of the geographic region including a plurality of nodes connected by a plurality of edges and one or more statistical measures corresponding to the plurality of overall performance metrics of the wireless communication network for each of the plurality of nodes. The one or more back-end servers execute instructions to receive, from a vehicle that is part of the plurality of vehicles, a navigational request for one of the following: the network connectivity performance road map of the geographical region and a navigational route calculated based on the network connectivity performance road map. In response to receiving the navigational request, the one or more back-end servers calculate the one or more statistical measures corresponding to the plurality of overall performance metrics of the wireless communication network for each of the plurality of edges of the map data road graph of the geographic region. The one or more back-end servers determine the network connectivity performance road map of the geographical region based on the one or more statistical measures corresponding to the plurality of overall performance metrics for each of the plurality of nodes and each of the plurality of edges. The one or more back-end servers annotate each of the plurality of nodes that are part of the network connectivity performance road map with the live network performance data of the wireless communication network and transmit the network connectivity performance road map over the wireless communication network to the vehicle that transmitted the navigational request.

In another aspect, the one or more back-end servers calculate the one or more statistical measures corresponding to the plurality of overall performance metrics of the wireless communication network for each of the plurality of edges of the map data road graph of the geographic region by averaging of the one or more statistical measures corresponding to the plurality of overall performance metrics for two neighboring nodes connected to one another by a single edge, and assigning an average value for the two neighboring nodes to the single edge.

In yet another aspect, the overall performance metrics of the wireless communication network include one or more of the following: an end-to-end latency, wireless communication latency, network bandwidth, bandwidth utilization, jitter, server computational time, server resource utilization, server geographic location, and a geographic location of a specific vehicle collecting the corresponding overall performance data.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a schematic diagram of the disclosed evaluation system for determining a network connectivity performance road map indicating overall performance metrics of a wireless communication network including one or more back-end servers in wireless communication with a plurality of vehicles, according to an exemplary embodiment;

FIG. 2 is a diagram illustrating the software architecture for the one or more back-end servers and one or more controllers that are part of one of the vehicles shown in FIG. 1, according to an exemplary embodiment;

FIG. 3 is an example of a map data graph structure of the geographic region, where the map data graph structure includes a plurality of nodes that are connected to one another by a plurality of edges, according to an exemplary embodiment;

FIG. 4 is a process flow diagram illustrating a method for determining the network connectivity performance road map by the evaluation system, according to an exemplary embodiment; and

FIG. 5 is a process flow diagram illustrating a method for determining one or more basic route plans and one or more performance-based route plans by the evaluation system, according to an exemplary embodiment.

### DETAILED DESCRIPTION

The following description is merely exemplary in nature and is not intended to limit the present disclosure, application, or uses.

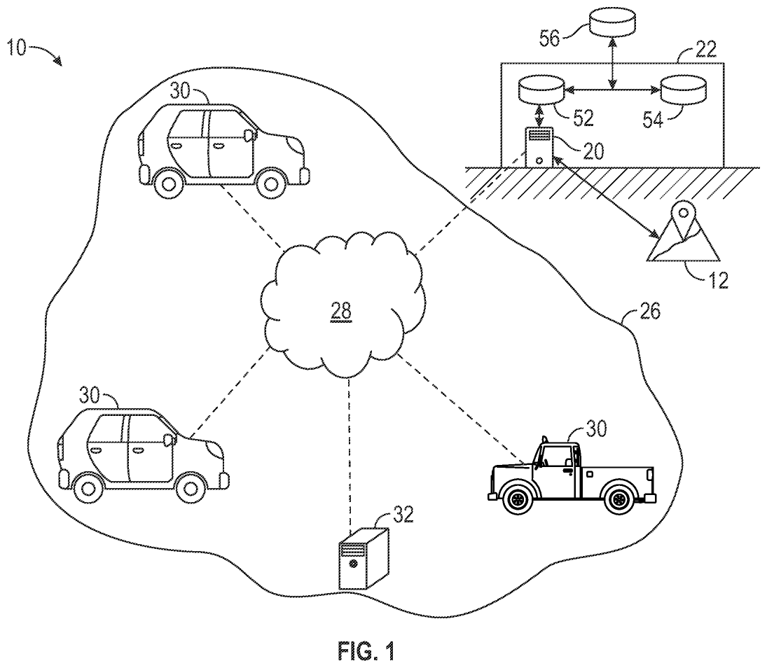

Referring to FIG. 1, an exemplary evaluation system 10 that generates a network connectivity performance road map 12 is illustrated. The evaluation system 10 includes one or more back-end servers 20 located at a back-end office 22. The one or more back-end servers 20 are in wireless communication with a plurality of vehicles 24 located within a geographic region 26 via a wireless communication network 28. It is to be appreciated that the plurality of vehicles 24 may each be any type of vehicle such as, but not limited to, a sedan, a truck, sport utility vehicle, van, or motor home. In the non-limiting embodiment as shown in FIG. 1, each vehicle 24 includes one or more controllers 30. The wireless communication network 28 connects each of the one or more controllers 30 of each vehicle 24 with the one or more back-end servers 20. Some examples of wireless network communication protocols that the wireless communication network 28 is based upon include, but are not limited to, cellular vehicle-to-everything (C-V2X), dedicated short-range communication (DSRC) networks, or a wireless network protocol based on the Institute of Electrical and Electronics Engineers (IEEE) 802.11 family of standards.

In one embodiment, the wireless communication network 28 also connects one or more network servers 32 that are part of the wireless communication network 28 with the one or more back-end servers 20. The network servers 32 transmit live network performance data such as, but not limited to, the real-time latency of the wireless communication network 28 to the one or more back-end servers 20. In one embodiment, one or more of the vehicles 24 receive the live network performance data from the back-end servers 20 over the wireless communication network 28. A vehicle 24 may re-calculate its current route in the event the live network performance data indicates low network connectivity performance along a particular road segment of the current route. It is also to be appreciated that transmitting the live network latency data from the network servers 32 is optional and may be omitted in some implementations.

As explained below, the one or more back-end servers 20 create the network connectivity performance road map 12 based on one or more overall performance metrics of the wireless communication network 28 collected by the plurality of vehicles 24. As explained below, the one or more overall performance metrics of the wireless communication network 28 includes one or more performance metrics of the one or more back-end servers 20 as well. The network connectivity performance road map 12 indicates one or more overall performance metrics of the wireless communication network 28 within the geographic region 26 where the plurality of vehicles 24 are located, where the overall performance metrics are collected by the plurality of vehicles 24. Some examples of overall performance metrics of the wireless communication network 28 include, but are not limited to, an end-to-end latency, wireless communication latency, network bandwidth, bandwidth utilization, jitter, server computational time, server resource utilization, server geographic location, server hardware, and a geographic location of the specific vehicle 24 collecting the corresponding overall performance data. As another example, if the wireless communication network 28 is transmitting video files, then the overall performance metrics may include, for example, a frame rate (measured in frames-per-second) and a resolution of the frames. In one embodiment, the network connectivity performance road map 12 may be annotated with the live network performance data of the wireless communication network 28 collected by the network servers 32. In embodiments, the one or more back-end servers 20 then transmit the network connectivity performance road map 12 over the wireless communication network 28 to the plurality of vehicles 24. However, in another embodiment the network connectivity performance road map 12 is stored in memory by the back-end servers 20, and a navigational route calculated based on the network connectivity performance road map 12 is transmitted to the plurality of vehicles 24.

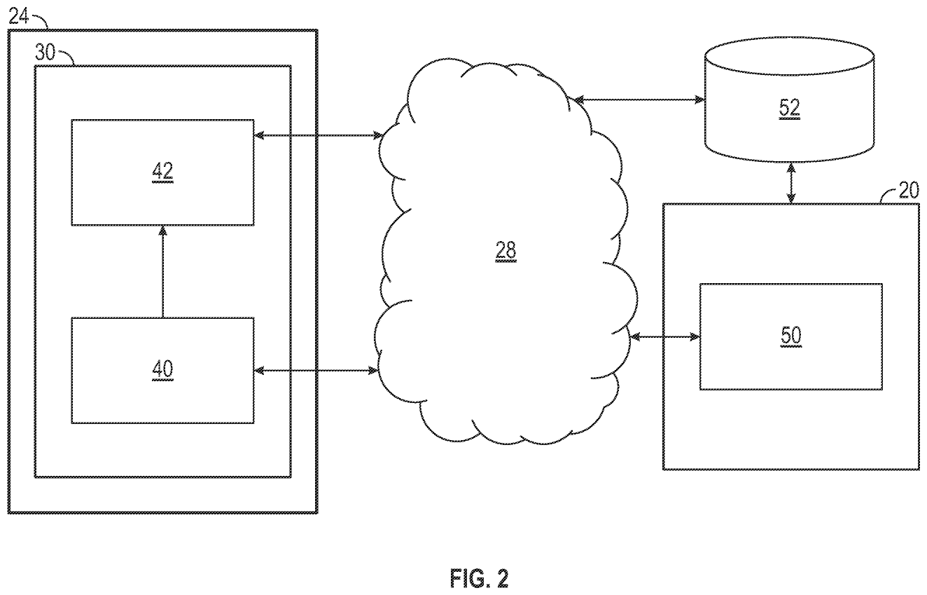

FIG. 2 is a block diagram illustrating the software architecture of the one or more back-end servers 20 and the one or more controllers 30 of one of the vehicles 24. It is to be appreciated that the one or more controllers 30 of the vehicle 24 executes one or more applications 40. It is to be appreciated that the one or more applications 40 require data from the wireless communication network 28. Some examples of the vehicle applications 40 include, but are not limited to, a navigational application, a video application for streaming video files, or an audio application for streaming audio files. The one or more controllers 30 of the vehicle 24 also includes a network performance monitoring module 42 that receives one or more wireless network performance metrics from the one or more vehicle applications 40, where the wireless network performance metrics are indicative of the performance of the wireless communication network 28. Some examples of wireless network performance metrics include, but are not limited to, the end-to-end latency, the wireless communication latency, the network bandwidth, jitter, and the geographic location of the specific vehicle 24 collecting the corresponding overall performance data. The network performance monitoring module 42 of the one or more controllers 30 of the vehicle 24 transmits the wireless network performance metrics for the one or more vehicle applications 40 over the wireless communication network 28 to the network connectivity performance database 52.

Referring to both FIGS. 1 and 2, the one or more back-end servers 20 include a workload processing server 50 (shown in FIG. 2). The one or more back-end servers 20 are in electronic communication with a network connectivity performance database 52, a road map database 54, and a road network database 56. As seen in FIG. 1, in one embodiment, the network connectivity performance database 52 and the road network database 56 are located at the back-end office 22, however, it is to be appreciated that FIG. 1 is merely exemplary and the network connectivity performance database 52 and the road network database 56 may be stored in another location remote from the back-end office 22 as well.

Referring to FIG. 2, at least a portion of the computational workload required to execute the one or more applications 40 is offloaded from the one or more controllers 30 of the vehicle 24 to the workload processing server 50 of the one or more back-end servers 20. The workload processing server 50 of the one or more back-end servers 20 executes the one or more applications 40 that have been offloaded from the one or more controllers 30 of the vehicle 24. The workload processing server 50 of the one or more back-end servers 20 transmits back-end server performance metrics related to executing the application 40 to the network connectivity performance database 52. Some examples of the back-end server performance metrics related to executing the application 40 include, but are not limited to, the server computational time, the server resource utilization, and the server geographic location. The back-end server performance metrics received from the workload processing server 50 are combined with the wireless network performance metrics received from the controllers 30 of the plurality of vehicles 24 together to create the overall performance metrics of the wireless communication network 28, where the overall performance metrics are stored in the network connectivity performance database 52.

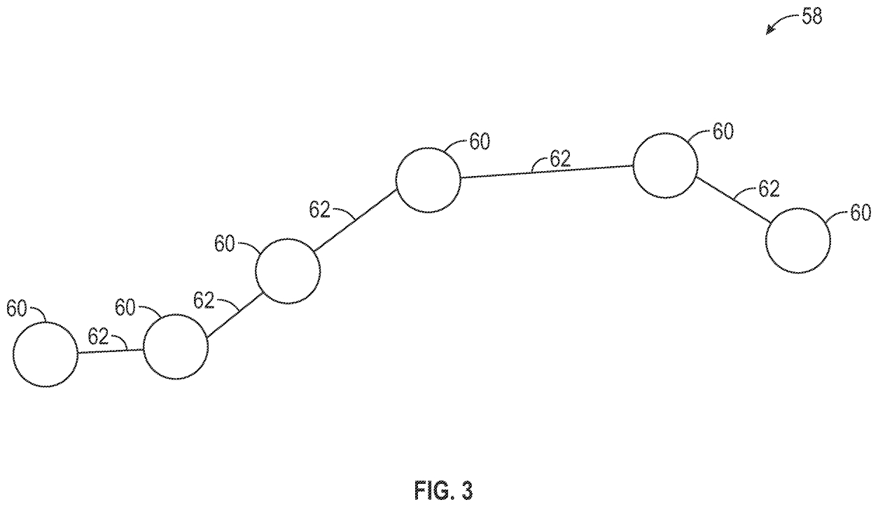

FIG. 3 is an illustration of an exemplary map data graph structure 58 of the geographic region 26 (FIG. 1), where the map data graph structure 58 is stored in the road map database 54 (FIG. 1). Referring to FIGS. 1 and 3, the road network database 56 stores road network data corresponding to the geographic region 26 where the plurality of vehicles 24 are located. One example of the road network data is the open street map (OSM), however, it is to be appreciated that other types of road network data may be used as well. The map data graph structure 58 includes a plurality of nodes 60 that are connected to one another by a plurality of edges 62. The plurality of nodes 60 and the edges 62 are part of the road network data received by the one or more back-end servers 20.

As explained below, the one or more back-end servers 20 determine the map data graph structure 58 by annotating the plurality of nodes 60, which are part of the road network data received from the road network database 56, with the overall performance metrics for the wireless communication network 28, which is stored by the network connectivity performance database 52. The map data graph structure 58 includes the plurality of nodes 60 that are connected to one another by the plurality of edges 62, where the nodes 60 represent stationary elements in the geographic region 26 where the plurality of vehicles 24 are located, and the edges 62 represents roadways that connect the nodes 60 to one another. Some examples of the elements represented by the nodes 60 include, but are not limited to, buildings such as schools, offices, and residences, and an intersection of a roadway.

Referring to both FIGS. 2 and 3, the one or more back-end servers 20 compute one or more statistical measures of the overall performance metrics for each of the plurality of nodes 60 that are part of the geographic region 26 (FIG. 1) represented by the map data graph structure 58. The one or more statistical measures refers to statistic distribution terms such as, but not limited to, the mean and the median of a specific overall performance metric of the wireless communication network 28. The one or more back-end servers 20 determine the one or more statistical measures of the overall performance metrics for each of the plurality of nodes 60 by first retrieving the overall performance metrics stored in the network connectivity performance database 52. The one or more back-end servers 20 then group the overall performance metrics based on a date and time when a specific overall performance metric was collected.

The one or more back-end servers 20 then obtain the road network data corresponding to the geographic region 26 represented by the network connectivity performance road map 12 from the road network database 56. The one or back-end servers 20 associate the overall performance metrics with one of the nodes 60 that are part of the geographic region 26 (FIG. 1) represented by the map data graph structure 58 based on the geographic location of the specific vehicle 24 that collected the overall performance data. The one or more back-end servers 20 then compute the one or more statistical measures of the overall performance metrics for each node 60 that is part of the geographic region 26 represented by the network connectivity performance road map 12. Finally, the one or more back-end servers 20 store the one or more statistical measures of the overall performance metrics of the wireless communication network 28 for each node 60 that is part of the geographic region 26 represented by the map data graph structure 58 in the one or more road map databases 54.

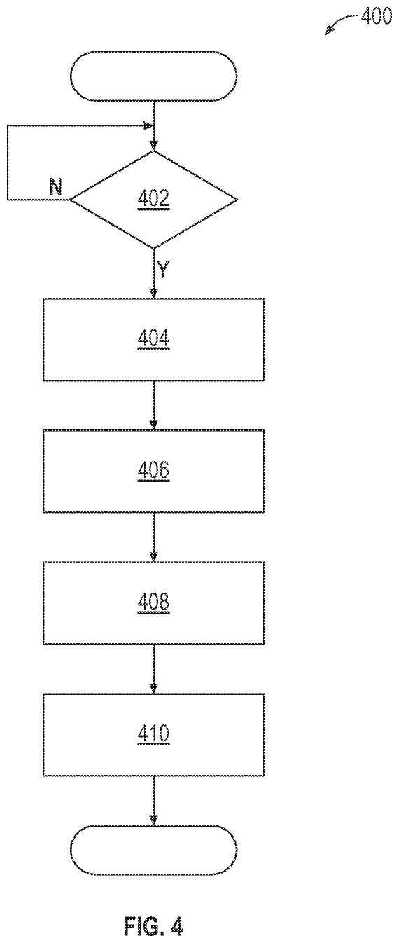

Referring to FIGS. 1, 2, and 3, the one or more back-end servers 20 of the evaluation system 10 determine the network connectivity performance road map 12 based on the one or more one or more statistical measures of the overall performance metrics of the wireless communication network 28. FIG. 4 is a process flow diagram illustrating a method 400 for determining the network connectivity performance road map 12 shown in FIG. 1. Referring generally to FIGS. 1-4, the method 400 may begin at decision block 402. In decision block 402, the one or more back-end servers 20 continue to monitor the wireless communication network 28 until receiving a navigational request. The navigational request is for the network connectivity performance road map 12 of the geographical region 26 from one of the vehicles 24 (shown in FIG. 1) or the navigational route calculated based on the network connectivity performance road map 12. In response to receiving the navigational request, the method 400 may then proceed to block 404.

In block 404, in response to receiving the navigational request, the one or more back-end servers 20 calculate the one or more statistical measures corresponding to the plurality of overall performance metrics of the wireless communication network 28 for each of the plurality of edges 62 (FIG. 3) of the map data graph structure 58 of the geographic region 26. Specifically, the one or more back-end servers 20 calculate the one or more statistical measures corresponding to the plurality of overall performance metrics of the wireless communication network 28 for each edge 62 by averaging the one or more statistical measures corresponding to the plurality of overall performance metrics for two neighboring nodes 60 connected to one another by a single edge 62. The one or more back-end servers 20 then assign an average value for the two neighboring nodes 60 to the single edge 62. The method 400 may then proceed to block 406.

In block 406, the one or more back-end servers 20 determine the network connectivity performance road map 12 of the geographical region 26 based on the one or more statistical measures corresponding to the plurality of overall performance metrics for each of the plurality of nodes and each of the plurality of edges 62. The method 400 may then proceed to block 408.

In block 408, the one or more back-end servers 20 annotate each of the plurality of nodes 60 that are part of the network connectivity performance road map 12 of the geographical region 26 with the live network performance data of the wireless communication network 28 received from the one or more network servers 32. It is to be appreciated that block 408 is optional. The method 400 may then proceed to block 410.

In block 410, the one or more back-end servers 20 transmit the network connectivity performance road map 12 over the wireless communication network 28 to the vehicle 24 that generated the navigational request for the network connectivity performance road map 12. The vehicle 24 utilizes the network connectivity performance road map 12 when performing one or more connected vehicle functions. Some examples of connected vehicle functions include, but are not limited to, audio data streaming, video data streaming, and navigation and mapping. It is to be appreciated that in some embodiments, instead of transmitting the network connectivity performance road map 12 to the vehicles 24 the back-end servers 20 transmit navigation routes to the vehicles 24, where the navigation routes are calculated based on the network connectivity performance road map 12. The method 400 may then terminate.

In one embodiment, the one or more back-end servers 20 receive a route request from one of the vehicles 24, where the route request includes a start location, an end destination, and a vehicle specification. The vehicle specification refers to identification information, the model year, and the hardware and computational capability of a vehicle. The one or more back-end servers 20 determine one or more basic route plans by minimizing a distance-based cost and a time-based cost associated with each edge 62 (FIG. 3) between the start location and the end destination of the route request. The one or more back-end servers 20 also determine one or more network performance-based route plans by minimizing an end-to-end latency cost and a network live latency cost associated with each edge 62 between the start location and the end destination of the route request.

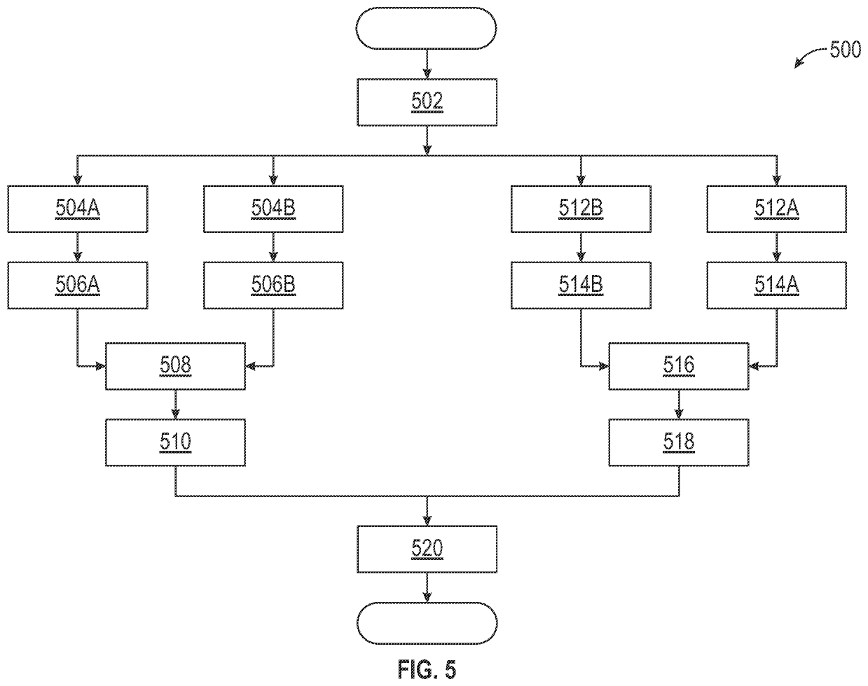

FIG. 5 is a process flow diagram illustrating a method 500 for determining the basic route plan and the network performance-based route plan by the one or more back-end servers 20. It is to be appreciated that the basic route plan and the performance-based route plan may be determined in parallel with one another. Also, blocks 504A, 504B, 506A, 506B, 508, and 510 of the method 500 describe determining the basic route plan, while blocks 512A, 512B, 514A, 514B, 516, and 518 describe the performance-based route plan. Referring generally to FIGS. 1-3 and 5, the method 500 may begin at block 502. In block 502, the one or more back-end servers 20 receive the route request from one of the vehicles 24, where the route request includes the start location and the end destination. The method 500 may then proceed to blocks 502A and 502B.

In block 504A, in response to receiving the route request, the one or more back-end servers 20 calculate a distance cost c_{d} for each of the edges 62 that are part of the network connectivity performance road map 12, where the distance cost c_{d} is based on a length of each of the edges 62. The one or more back-end servers 20 may also normalize or scale the c_{d}. The method 500 may then proceed to block 506A.

In block 506A, the one or more back-end servers 20 determine a weight value associated with the distance cost c_{d} based on one or more user-defined criteria. The user-defined criteria may reduce the weight value associated with the distance cost c_{d} if other factors such as time, traffic congestion, and live network coverage are more important to the user or may increase the weight value associated with the distance cost c_{d} if the distance is more important to the user when compared to the other factors. In one non-limiting embodiment, the weight value associated with the distance cost c_{d} is 0.3.

Referring to block 504B, the one or more back-end servers 20 calculate a time cost cₜ for each of the edges 62 that are part of the network connectivity performance road map 12, where the time cost c_{d} is based on an amount of time to navigate the length of the edge 62 when the vehicle 24 is traveling at an average speed of traffic. The one or more back-end servers 20 may also normalize or scale the time cost cₜ. The method 500 may then proceed to block 506B.

In block 506B, the one or more back-end servers 20 determine a weight value associated with the time cost cₜ based on the one or more user-defined criteria. In one non-limiting embodiment, the weight value associated with the time cost cₜ is 0.7. It is to be appreciated that the sum of the weight value associated with the distance cost c_{d} and the weight value associated with the time cost cₜ is equal to 1. The method 500 may then proceed to block 508.

In block 508, the one or more back-end servers 20 combine the distance cost c_{d} and the time cost cₜ together based on the weight value associated with the distance cost c_{d} and the weight value associated with the time cost cₜ to determine a basic edge cost associated with each of the edges 62 that are part of the network connectivity performance road map 12. The method 500 may then proceed to block 510.

In block 510, the one or more back-end servers 20 determine one or more basic route plans by minimizing the basic edge cost associated with each of the edges 62 located between the start location and the end destination of the route request. In one non-limiting embodiment, the one or more back-end servers 20 determine the top twenty basic route plans by minimizing the basic edge cost.

Blocks 512A, 512B, 514A, 514B, 516, and 518 shall now be described. Referring to block 512A, in response to receiving the route request, the one or more back-end servers 20 calculate an offloading cost cₒ for each of the edges 62 that are part of the network connectivity performance road map 12, where the offloading cost cₒ is based on offloading the end-to-end latency of each of the edges 62 and is measured in milliseconds. The one or more back-end servers 20 may also normalize or scale the offloading cost cₒ. The method 500 may then proceed to block 506A.

In block 514A, the one or more back-end servers 20 determine a weight value associated with the offloading cost cₒ based on one or more user-defined criteria. In one non-limiting embodiment, the weight value associated with the offloading cost cₒ is 0.6.

Referring to block 512B, the one or more back-end servers 20 calculate a network live latency cost cₙ for each of the edges 62 that are part of the network connectivity performance road map 12, where the network live latency cost cₙ is based on an average one-way latency of the edge 62 and is measured in milliseconds. The one or more back-end servers 20 may also normalize or scale the network live latency cost cₙ. The method 500 may then proceed to block 514B.

In block 514B, the one or more back-end servers 20 determine a weight value associated with the network live latency cost cₙ based on the one or more user-defined criteria. In one non-limiting embodiment, the weight value associated with the network live latency cost cₙ is 0.6. It is to be appreciated that the sum of the weight value associated with the network live latency cost cₙ and the weight value associated with the network live latency cost cₙ is equal to 1. The method 500 may then proceed to block 516.

In block 516, the one or more back-end servers 20 combine the offloading cost cₒ and the network live latency cost cₙ together based on the weight value associated with the offloading cost cₒ and the weight value associated with the network live latency cost cₙ to determine a network performance edge cost associated with each of the edges 62 that are part of the network connectivity performance road map 12. The method 500 may then proceed to block 518.

In block 518, the one or more back-end servers 20 determine one or more the network performance-based route plans by minimizing the network performance edge cost associated with each of the edges 62 located between the start location and the end destination of the route request. In one non-limiting embodiment, the one or more back-end servers 20 determine the top three basic route plans by minimizing the network performance edge cost.

In block 520, one or more back-end servers 20 transmit the one or more basic route plans and the one or more network performance-based route plans over the wireless communication network 28 to the vehicle 24 that generated the route request. The vehicle 24 may then determine a route plan based on either the one or more basic route plans or the one or more network performance-based route plans. The method 500 may then terminate.

Referring generally to the figures, the disclosed evaluation system for determining the network connectivity performance road map provides various technical effects and benefits. The network connectivity performance road map includes historic data collected by the vehicles indicating the performance of the wireless communication network, backend server capabilities, and in some implementations, the real-time latency of the wireless communication network. Accordingly, the network connectivity performance road map enables a vehicle to avoid roadways that have outdated or lacking wireless network infrastructure, or that have high network congestion depending upon the time of day. Furthermore, the real-time latency data enables a vehicle to avoid roadways that are expected to provide poor network coverage, such as a high-traffic event like a concert, political rally, or sporting event.

The controllers and the back-end servers may refer to, or be part of an electronic circuit, a combinational logic circuit, a field programmable gate array (FPGA), a processor (shared, dedicated, or group) that executes code, or a combination of some or all of the above, such as in a system-on-chip. Additionally, the controllers may be microprocessor-based such as a computer having a at least one processor, memory (RAM and/or ROM), and associated input and output buses. The processor may operate under the control of an operating system that resides in memory. The operating system may manage computer resources so that computer program code embodied as one or more computer software applications, such as an application residing in memory, may have instructions executed by the processor. In an alternative embodiment, the processor may execute the application directly, in which case the operating system may be omitted.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An evaluation system that determines a network connectivity performance road map, the evaluation system comprising:
one or more back-end servers in wireless communication with a plurality of vehicles located in a geographic region by a wireless communication network, wherein the plurality of vehicles collect a plurality of overall performance metrics of the wireless communication network; and
one or more road map databases in electronic communication with the one or more back-end servers, wherein the one or more road map databases store a map data road graph of the geographic region including a plurality of nodes connected by a plurality of edges and one or more statistical measures corresponding to the plurality of overall performance metrics of the wireless communication network for each of the plurality of nodes, and wherein the one or more back-end servers execute instructions to:
calculate the one or more statistical measures corresponding to the plurality of overall performance metrics of the wireless communication network for each of the plurality of edges of the map data road graph of the geographic region; and
determine the network connectivity performance road map of the geographical region based on the one or more statistical measures corresponding to the plurality of overall performance metrics for each of the plurality of nodes and each of the plurality of edges.

2. The evaluation system of claim 1, further comprising:
one or more one or more network servers in wireless communication with the one or more back-end servers by the wireless communication network, wherein the one or more network servers transmit live network performance data of the wireless communication network to the one or more back-end servers.

3. The evaluation system of claim 2, wherein the one or more back-end servers execute instructions to:
annotate each of the plurality of nodes that are part of the network connectivity performance road map with the live network performance data of the wireless communication network.

4. The evaluation system of claim 1, wherein the one or more back-end servers execute instructions to:
receive, from a vehicle that is part of the plurality of vehicles, a navigational request for one of the following: the network connectivity performance road map of the geographical region and a navigational route calculated based on the network connectivity performance road map; and
transmit either the network connectivity performance road map or the navigational route over the wireless communication network to the vehicle that transmitted the navigational request.

5. The evaluation system of claim 1, wherein the one or more back-end servers calculate the one or more statistical measures corresponding to the plurality of overall performance metrics of the wireless communication network for each of the plurality of edges of the map data road graph of the geographic region by:
averaging of the one or more statistical measures corresponding to the plurality of overall performance metrics for two neighboring nodes connected to one another by a single edge; and
assigning an average value for the two neighboring nodes to the single edge.

6. The evaluation system of claim 1, wherein the one or more back-end servers execute instructions to:
receive, from one of the vehicles, a route request including a start location and an end destination;
in response to receiving the route request, calculate a distance cost for each of the plurality of edges that are part of the network connectivity performance road map; and
calculate a time cost for each of the plurality of edges that are part of the network connectivity performance road map.

7. The evaluation system of claim 6, wherein the one or more back-end servers execute instructions to:
combine the distance cost and the time cost together based on a weight value associated with the distance cost and a weight value associated with the time cost to determine a basic edge cost associated with each of the edges that are part of the network connectivity performance road map; and
determine one or more basic route plans by minimizing the basic edge cost associated with each of the edges located between the start location and the end destination of the route request.

8. The evaluation system of claim 7, wherein the one or more back-end servers execute instructions to:
in response to receiving the route request, calculate an offloading cost for each of the plurality of edges that are part of the network connectivity performance road map; and
calculate a network live latency cost for each of the plurality of edges that are part of the network connectivity performance road map.

9. The evaluation system of claim 8, wherein the one or more back-end servers execute instructions to:
combine the offloading cost and the network live latency cost together based on a weight value associated with the offloading cost and the weight value associated with the network live latency cost to determine a network performance edge cost associated with each of the plurality of edges that are part of the network connectivity performance road map; and
determine one or more network performance-based route plans by minimizing the network performance edge cost associated with each of the plurality of edges located between the start location and the end destination of the route request.

10. The evaluation system of claim 1, wherein the overall performance metrics of the wireless communication network include one or more of the following: an end-to-end latency, wireless communication latency, network bandwidth, bandwidth utilization, jitter, server computational time, server resource utilization, server geographic location, server hardware, and a geographic location of a specific vehicle collecting the corresponding overall performance data.

11. A method for determining a network connectivity performance road map by an evaluation system, the method comprising:
receiving, from a vehicle that is part of a plurality of vehicles located in a geographic region, a navigational request for one of the following: the network connectivity performance road map of the geographical region by one or more back-end servers and a navigational route calculated based on the network connectivity performance road map, wherein the one or more back-end servers are in wireless communication with the plurality of vehicles by a wireless communication network and the plurality of vehicles collect a plurality of overall performance metrics of the wireless communication network;
in response to receiving the navigational request, calculate one or more statistical measures corresponding to the plurality of overall performance metrics of the wireless communication network for each of a plurality of edges of a map data road graph of the geographic region that are stored in one or more road map databases that are in electronic communication with the one or more back-end servers, wherein the map data road graph of the geographic region includes a plurality of nodes connected by the plurality of edges and the one or more road map databases store one or more statistical measures corresponding to the plurality of overall performance metrics of the wireless communication network for each of the plurality of nodes; and
determining the network connectivity performance road map of the geographical region based on the one or more statistical measures corresponding to the plurality of overall performance metrics for each of the plurality of nodes and each of the plurality of edges.

12. The method of claim 11, further comprising:
transmitting, by one or more one or more network servers in wireless communication with the one or more back-end servers by the wireless communication network, live network performance data of the wireless communication network to the one or more back-end servers.

13. The method of claim 12, further comprising:
annotating each of the plurality of nodes that are part of the network connectivity performance road map with the live network performance data of the wireless communication network.

14. The method of claim 12, further comprising:
receiving, from the vehicle, a route request including a start location and an end destination;
in response to receiving the route request, calculating a distance cost for each of the plurality of edges that are part of the network connectivity performance road map; and
calculating a time cost for each of the plurality of edges that are part of the network connectivity performance road map.

15. The method of claim 14, further comprising:
combining the distance cost and the time cost together based on a weight value associated with the distance cost and a weight value associated with the time cost to determine a basic edge cost associated with each of the edges that are part of the network connectivity performance road map; and
determining one or more basic route plans by minimizing the basic edge cost associated with each of the edges located between the start location and the end destination of the route request.

16. The method of claim 15, further comprising:
in response to receiving the route request, calculating an offloading cost for each of the plurality of edges that are part of the network connectivity performance road map; and
calculating a network live latency cost for each of the plurality of edges that are part of the network connectivity performance road map.

17. The method of claim 16, further comprising:
combining the offloading cost and the network live latency cost together based on a weight value associated with the offloading cost and the weight value associated with the network live latency cost to determine a network performance edge cost associated with each of the plurality of edges that are part of the network connectivity performance road map; and
determining one or more network performance-based route plans by minimizing the network performance edge cost associated with each of the plurality of edges located between the start location and the end destination of the route request.

18. An evaluation system that determines a network connectivity performance road map, the evaluation system comprising:
one or more back-end servers in wireless communication with a plurality of vehicles located in a geographic region by a wireless communication network, wherein the plurality of vehicles collect a plurality of overall performance metrics of the wireless communication network;
one or more one or more network servers in wireless communication with the one or more back-end servers by the wireless communication network, wherein the one or more network servers transmit live network performance data of the wireless communication network to the one or more back-end servers; and
one or more road map databases in electronic communication with the one or more back-end servers, wherein the one or more road map databases store a map data road graph of the geographic region including a plurality of nodes connected by a plurality of edges and one or more statistical measures corresponding to the plurality of overall performance metrics of the wireless communication network for each of the plurality of nodes, and wherein the one or more back-end servers execute instructions to:
receive, from a vehicle that is part of the plurality of vehicles, a navigational request for one of the following: the network connectivity performance road map of the geographical region and a navigational route calculated based on the network connectivity performance road map;
in response to receiving the navigational request, calculate the one or more statistical measures corresponding to the plurality of overall performance metrics of the wireless communication network for each of the plurality of edges of the map data road graph of the geographic region;
determine the network connectivity performance road map of the geographical region based on the one or more statistical measures corresponding to the plurality of overall performance metrics for each of the plurality of nodes and each of the plurality of edges;
annotate each of the plurality of nodes that are part of the network connectivity performance road map with the live network performance data of the wireless communication network; and
transmit the network connectivity performance road map over the wireless communication network to the vehicle that transmitted the navigational request.

19. The evaluation system of claim 18, wherein the one or more back-end servers calculate the one or more statistical measures corresponding to the plurality of overall performance metrics of the wireless communication network for each of the plurality of edges of the map data road graph of the geographic region by:
averaging of the one or more statistical measures corresponding to the plurality of overall performance metrics for two neighboring nodes connected to one another by a single edge; and
assigning an average value for the two neighboring nodes to the single edge.

20. The evaluation system of claim 18, wherein the overall performance metrics of the wireless communication network include one or more of the following: an end-to-end latency, wireless communication latency, network bandwidth, bandwidth utilization, jitter, server computational time, server resource utilization, server geographic location, and a geographic location of a specific vehicle collecting the corresponding overall performance data.
